(19) United States
(12) Patent Application Publication
(10) Pub. No.: US 2007/0088111 A1
(43) Pub. Date: Apr. 19, 2007

(54) COATING COMPOSITIONS EXHIBITING CORROSION RESISTANCE PROPERTIES, RELATED COATED SUBSTRATES, AND METHODS

(75) Inventors: Ljiljana Maksimovic, Allison Park, PA (US); Edward R. Millero JR., Gibsonia, PA (US); Mykola Vasyl'ovych Borysenko, Kyiv (UA); Mykola Oleksandrovych Ogurtsov, Kyiv (UA)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/567,947

(22) Filed: Dec. 7, 2006

Related U.S. Application Data
(63) Continuation-in-part of application No. 11/213,136, filed on Aug. 26, 2005.

(51) Int. Cl. C08K 3/10; C08K 3/32; C08K 3/34; B32B 27/00

(52) U.S. Cl. 524/401; 524/417; 524/437

(57) ABSTRACT

Coating compositions are disclosed that include corrosion resisting particles such that the coating composition can exhibit corrosion resistance properties. Also disclosed are substrates at least partially coated with a coating deposited from such a composition and multi-component composite coatings, wherein at least one coating layer is deposited from such a coating composition. Methods and apparatus for making ultrafine solid particles are also disclosed.

### CROSS-REFERENCE TO RELATED APPLICATION

This application is a continuation-in-part of U.S. patent application Ser. No. 11/213,136, filed Aug. 26, 2005, which is incorporated herein by reference.

### FIELD OF THE INVENTION

The present invention relates to coating compositions that comprise corrosion resisting particles such that the coating compositions exhibit corrosion resistance properties. The present invention also relates to substrates at least partially coated with a coating deposited from such a composition and multi-component composite coatings, wherein at least one coating layer is deposited from such a coating composition. The present invention is also related to methods and apparatus for making ultrafine solid particles.

### BACKGROUND OF THE INVENTION

Coating systems that are deposited onto a substrate and cured, such as “color-plus-clear” and “monocoat” coating systems, can be subject to damage from the environment. For example, corrosion of a coated metallic substrate can occur as the substrate is exposed to oxygen and water present in the atmosphere. As a result, a “primer” coating layer is often used to protect the substrate from corrosion. The primer layer is often applied directly to a bare or pretreated metallic substrate. In some cases, particularly where the primer layer is to be applied over a bare metallic substrate, the primer layer is deposited from a composition that includes a material, such as an acid, such as phosphoric acid, which enhances the adhesion of the primer layer to the substrate. Such primers are sometimes known as “etch primers”.

As indicated, in some cases metallic substrates are “pretreated” before a primer coating layer is applied (if such a primer coating is used). Such “pretreatments” often involve the application of a phosphate conversion coating, followed by a rinse, prior to the application of a protective or decorative coating. The pretreatment often acts to passivate the metal substrate and promotes corrosion resistance.

Historically, corrosion resistant “primer” coatings and metal pretreatments have utilized chromium compounds and/or other heavy metals, such as lead, to achieve a desired level of corrosion resistance and adhesion to subsequently applied coatings. For example, metal pretreatments often utilize phosphate conversion coating compositions that contain heavy metals, such as nickel, and post-rinses that contain chrome. In addition, the compositions used to produce a corrosion resistant “primer” coating often contain chromium compounds. An example of such a primer composition is disclosed in U.S. Pat. No. 4,069,187. The use of chromium and/or other heavy metals, however, results in the production of waste streams that pose environmental concerns and disposal issues.

More recently, efforts have been made to reduce or eliminate the use of chromium and/or other heavy metals. As a result, coating compositions have been developed that contain other materials added to inhibit corrosion. These materials have included, for example, zinc phosphate, iron phosphate, zinc molybdate, and calcium molybdate particles, among others, and typically comprise particles having a particle size of approximately a micron or larger. The corrosion resistance capability of such compositions, however, has been inferior to their chrome containing counterparts.

As a result, it would be desirable to provide coating compositions that are substantially free of chromium and/or other heavy metals, wherein the compositions can, in at least some cases, exhibit corrosion resistance properties superior to a similar non-chrome containing composition. In addition, it would be desirable to provide methods for treating metal substrates to improve the corrosion resistance of such substrates, wherein the method does not involve the use of chromium and/or other heavy metals.

### SUMMARY OF THE INVENTION

In certain respects, the present invention is directed to coating compositions, such as metal substrate primer and/or pretreatment coating compositions, that comprise: (1) an adhesion promoting component, and (2) corrosion resisting particles comprising an inorganic oxide in combination with a pH buffering agent.

In certain respects, the present invention is directed to coating compositions, such as metal substrate primer and/or pretreatment coating compositions, that comprise: (1) an adhesion promoting component, and (2) corrosion resisting particles comprising an inorganic oxide in combination with a pH buffering agent and a polyamine.

The present invention also relates to methods for providing substantially chromium free corrosion resistant coating compositions as well as methods for enhancing the corrosion resistance of a metal substrate.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. For example, and without limitation, this application refers to coating compositions that, in certain embodiments, comprise a “film-forming resin.” Such references to “a film-forming resin” is meant to encompass coating compositions comprising one film-forming resin as well as coating compositions that comprise a mixture of two or more film-forming resins. In addition, in this application, the use of “or” means “and/or” unless specifically stated otherwise, even though “and/or” may be explicitly used in certain instances.

In certain embodiments, the present invention is directed to coating compositions that are substantially free of chromium containing material. In other embodiments, the coating compositions of the present invention are completely free of such a material. As used herein, the term “substantially free” means that the material being discussed is present in the composition, if at all, as an incidental impurity. In other words, the material does not affect the properties of the composition. This means that, in certain embodiments of the present invention, the coating composition contains less than 2 weight percent of chromium containing material or, in some cases, less than 0.05 weight percent of chromium containing material, wherein such weight percents are based on the total weight of the composition. As used herein, the term “completely free” means that the material is not present in the composition at all. Thus, certain embodiments of the coating compositions of the present invention contain no chromium-containing material. As used herein, the term “chromium containing material” refers to materials that include a chromium trioxide group, CrO₃. Non-limiting examples of such materials include chromic acid, chromium trioxide, chromic acid anhydride, dichromate salts, such as ammonium dichromate, sodium dichromate, potassium dichromate, and calcium, barium, magnesium, zinc, cadmium, and strontium dichromate.

Certain embodiments of the coating compositions of the present invention are substantially free of other undesirable materials, including heavy metals, such as lead and nickel. In certain embodiments, the coating compositions of the present invention are completely free of such materials.

As indicated, the coating compositions of the present invention comprise “corrosion resisting particles.” As used herein, the term “corrosion resisting particles” refers to particles which, when included in a coating composition that is deposited upon a substrate, act to provide a coating that resists or, in some cases, even prevents, the alteration or degradation of the substrate, such as by a chemical or electrochemical oxidizing process, including rust in iron containing substrates and degradative oxides in aluminum substrates.

In certain embodiments, the present invention is directed to coating compositions that comprise particles comprising an inorganic oxide, in some embodiments a plurality of inorganic oxides, such as, for example, zinc oxide (ZnO), magnesium oxide (MgO), cerium oxide (CeO₂), molybdenum oxide (MoO₃), and/or silicon dioxide (SiO₂), among others. As used herein, the term “plurality” means two or more. Therefore, certain embodiments of coating compositions of the present invention comprise corrosion resisting particles comprising two, three, four, or more than four inorganic oxides. In certain embodiments, these inorganic oxides are present in such particles, for example, in the form of a homogeneous mixture or a solid-state solution of the plurality of oxides.

In certain embodiments of the coating compositions of the present invention, the corrosion resisting particles comprising an inorganic oxide, or, in certain embodiments, a plurality thereof, comprise an oxide of zinc, cerium, yttrium, manganese, magnesium, molybdenum, lithium, aluminum, magnesium, tin, or calcium. In certain embodiments, the particles comprise an oxide of magnesium, zinc, cerium, or calcium. In certain embodiments, the particles also comprise an oxide of boron, phosphorous, silicon, zirconium, iron, or titanium. In certain embodiments, the particles comprise silicon dioxide (hereinafter identified as “silica”).

In certain embodiments, the corrosion resisting particles that are included within certain embodiments of the coating compositions of the present invention comprise a plurality of inorganic oxides selected from (i) particles comprising an oxide of cerium, zinc, and silicon; (ii) particles comprising an oxide of calcium, zinc and silicon; (iii) particles comprising an oxide of phosphorous, zinc and silicon; (iv) particles comprising an oxide of yttrium, zinc, and silicon; (v) particles comprising an oxide of molybdenum, zinc, and silicon; (vi) particles comprising an oxide of boron, zinc, and silicon; (vii) particles comprising an oxide of cerium, aluminum, and silicon, (viii) particles comprising oxides of magnesium or tin and silicon, and (ix) particles comprising an oxide of cerium, boron, and silicon, or a mixture of two or more of particles (i) to (ix).

In certain embodiments, the corrosion resisting particles included in the coating compositions of the present invention are substantially free, or, in some cases, completely free of an oxide of zirconium. In certain embodiments, this means that the corrosion resisting particles contain less than 1 percent by weight zirconium oxide or, in some cases, less than 0.05 percent by weight zirconium oxide, wherein such weight percents are based on the total weight of the particle.

In certain embodiments of the coating compositions of the present invention, the corrosion resisting particles comprise 10 to 25 percent by weight zinc oxide, 0.5 to 25 percent by weight cerium oxide, and 50 to 89.5 percent by weight silica, wherein the percents by weight are based on the total weight of the particle. In certain embodiments, such particles are substantially free, or, in some cases, completely free of zirconium.

In other embodiments of the coating compositions of the present invention, the corrosion resisting particles comprise 10 to 25 percent by weight zinc oxide, 0.5 to 25 percent by weight calcium oxide, and 50 to 89.5 percent by weight silica, wherein the percents by weight are based on the total weight of the particle. In certain embodiments, such particles are substantially free, or, in some cases, completely free of zirconium.

In still other embodiments of the coating compositions of the present invention, the corrosion resisting particles comprise 10 to 25 percent by weight zinc oxide, 0.5 to 25 percent by weight yttrium oxide, and 50 to 89.5 percent by weight silica, wherein the percents by weight are based on the total weight of the particle. In certain embodiments, such particles are substantially free, or, in some cases, completely free of zirconium.

In yet other embodiments of the coating compositions of the present invention, the corrosion resisting particles comprise 10 to 25 percent by weight zinc oxide, 0.5 to 50 percent by weight phosphorous oxide, and 25 to 89.5 percent by weight silica, wherein the percents by weight are based on the total weight of the particle. In certain embodiments, such particles are substantially free, or, in some cases, completely free of zirconium.

In some embodiments of the coating compositions of the present invention, the corrosion resisting particles comprise 10 to 25 percent by weight zinc oxide, 0.5 to 50 percent by weight boron oxide, and 25 to 89.5 percent by weight silica, wherein the percents by weight are based on the total weight of the particle. In certain embodiments, such particles are substantially free, or, in some cases, completely free of zirconium.

In certain embodiments of the coating compositions of the present invention, the corrosion resisting particles comprise 10 to 25 percent by weight zinc oxide, 0.5 to 50 percent by weight molybdenum oxide, and 25 to 89.5 percent by weight silica, wherein the percents by weight are based on the total weight of the particle. In certain embodiments, such particles are substantially free, or, in some cases, completely free of zirconium.

In other embodiments of the coating compositions of the present invention, the corrosion resisting particles comprise 0.5 to 25 percent by weight cerium oxide, 0.5 to 50 percent by weight boron oxide, and 25 to 99 percent by weight silica, wherein the percents by weight are based on the total weight of the particle. In certain embodiments, such particles are substantially free, or, in some cases, completely free of zirconium.

In still other embodiments of the coating compositions of the present invention, the corrosion resisting particles comprise 0.5 to 25 percent by weight cerium oxide, 0.5 to 50 percent by weight aluminum oxide, and 25 to 99 percent by weight silica, wherein the percents by weight are based on the total weight of the particle. In certain embodiments, such particles are substantially free, or, in some cases, completely free of zirconium.

In yet other embodiments of the coating compositions of the present invention, the corrosion resisting particles comprise 0.5 to 25 percent by weight cerium oxide, 0.5 to 25 percent by weight zinc oxide, 0.5 to 25 percent by weight boron oxide, and 25 to 98.5 percent by weight silica, wherein the percents by weight are based on the total weight of the particle. In certain embodiments, such particles are substantially free, or, in some cases, completely free of zirconium.

In certain embodiments of the coating compositions of the present invention, the corrosion resisting particles comprise 0.5 to 25 percent by weight yttrium oxide, 0.5 to 25 percent by weight phosphorous oxide, 0.5 to 25 percent by weight zinc oxide, and 25 to 98.5 percent by weight silica, wherein the percents by weight are based on the total weight of the particle. In certain embodiments, such particles are substantially free, or, in some cases, completely free of zirconium.

In certain embodiments of the coating compositions of the present invention, the corrosion resisting particles comprise 0.5 to 75 percent by weight magnesium or tin oxide, and 25 to 99.5 percent by weight silica, wherein the percents by weight are based on the total weight of the particle. In certain embodiments, such particles are substantially free, or, in some cases, completely free of zirconium.

In some embodiments of the coating compositions of the present invention, the corrosion resisting particles comprise 0.5 to 5 percent by weight yttrium oxide, 0.5 to 5 percent by weight molybdenum oxide, 0.5 to 25 percent by weight zinc oxide, 0.5 to 5 percent by weight cerium oxide and 60 to 98 percent by weight silica, wherein the percents by weight are based on the total weight of the particles. In certain embodiments, such particles are substantially free, or, in some cases, completely free of zirconium.

Certain embodiments of the coating compositions of the present invention comprise ultrafine corrosion resisting particles comprising an inorganic oxide, or in some embodiments, a plurality of inorganic oxides. As used herein, the term “ultrafine” refers to particles that have a B.E.T. specific surface area of at least 10 square meters per gram, such as 30 to 500 square meters per gram, or, in some cases, 80 to 250 square meters per gram. As used herein, the term “B.E.T. specific surface area” refers to a specific surface area determined by nitrogen adsorption according to the ASTMD 3663-78 standard based on the Brunauer-Emmett-Teller method described in the periodical “The Journal of the American Chemical Society”, 60, 309 (1938).

In certain embodiments, the coating compositions of the present invention comprise corrosion resisting particles having a calculated equivalent spherical diameter of no more than 200 nanometers, such as no more than 100 nanometers, or, in certain embodiments, 5 to 50 nanometers. As will be understood by those skilled in the art, a calculated equivalent spherical diameter can be determined from the B.E.T. specific surface area according to the following equation:
Diameter (nanometers)=6000/[BET(m²/g)*ρ(grams/cm³)]

Certain embodiments of the coating compositions of the present invention comprise corrosion resisting particles having an average primary particle size of no more than 100 nanometers, such as no more than 50 nanometers, or, in certain embodiments, no more than 20 nanometers, as determined by visually examining a micrograph of a transmission electron microscopy (“TEM”) image, measuring the diameter of the particles in the image, and calculating the average primary particle size of the measured particles based on magnification of the TEM image. One of ordinary skill in the art will understand how to prepare such a TEM image and determine the primary particle size based on the magnification and the Examples contained herein illustrate a suitable method for preparing a TEM image. The primary particle size of a particle refers to the smallest diameter sphere that will completely enclose the particle. As used herein, the term “primary particle size” refers to the size of an individual particle as opposed to an agglomeration of two or more individual particles.

In certain embodiments, the corrosion resisting particles have an affinity for the medium of the composition sufficient to keep the particles suspended therein. In these embodiments, the affinity of the particles for the medium is greater than the affinity of the particles for each other, thereby reducing or eliminating agglomeration of the particles within the medium.

The shape (or morphology) of the corrosion resisting particles can vary. For example, generally spherical morphologies can be used, as well as particles that are cubic, platy, or acicular (elongated or fibrous).

The ultrafine corrosion resisting particles that are included in certain embodiments of the coating compositions of the present invention may be prepared by various methods, including gas phase synthesis processes, such as, for example, flame pyrolysis, hot walled reactor, chemical vapor synthesis, among other methods. In certain embodiments, however, such particles are prepared by reacting together one or more organometallic and/or metal oxide precursors in a fast quench plasma system. In certain embodiments, the particles may be formed in such a system by: (a) introducing materials into a plasma chamber; (b) rapidly heating the materials by means of a plasma to yield a gaseous product stream; (c) passing the gaseous product stream through a restrictive convergent-divergent nozzle to effect rapid cooling and/or utilizing an alternative cooling method, such as a cool surface or quenching stream, and (d) condensing the gaseous product stream to yield ultrafine solid particles. Certain suitable fast quench plasma systems and methods for their use are described in U.S. Pat. Nos. 5,749,937, 5,935,293, and RE37,853 E, which are incorporated herein by reference. One particular process of preparing ultrafine corrosion resisting particles suitable for use in certain embodiments of the coating compositions of the present invention comprises: (a) introducing one or more organometallic precursors and/or inorganic oxide precursors into one axial end of a plasma chamber; (b) rapidly heating the precursor stream by means of a plasma as the precursor stream flows through the plasma chamber, yielding a gaseous product stream; (c) passing the gaseous product stream through a restrictive convergent-divergent nozzle arranged coaxially within the end of the reaction chamber; and (d) subsequently cooling and slowing the velocity of the desired end product exiting from the nozzle, yielding ultrafine solid particles.

The precursor stream may be introduced to the plasma chamber as a solid, liquid, gas, or a mixture thereof. Suitable liquid precursors that may be used as part of the precursor stream include organometallics, such as, for example, cerium-2 ethylhexanoate, zinc-2 ethylhexanoate, tetraethoxysilane, calcium methoxide, triethylphosphate, lithium 2,4 pentanedionate, yttrium butoxide, molybdenum oxide bis(2,4-pentanedionate), trimethoxyboroxine, aluminum sec-butoxide, among other materials, including mixtures thereof. Suitable solid precursors that may be used as part of the precursor stream include solid silica powder (such as silica fume, fumed silica, silica sand, and/or precipitated silica), cerium acetate, cerium oxide, magnesium oxide, tin oxide, zinc oxide, and other oxides, among other materials, including mixtures thereof.

In certain embodiments, the ultrafine corrosion resisting particles that are included in certain embodiments of the coating compositions of the present invention are prepared by a method comprising: (a) introducing a solid precursor into a plasma chamber; (b) heating the precursor by means of a plasma to a selected reaction temperature as the precursor flows through the plasma chamber, yielding a gaseous product stream; (c) contacting the gaseous product stream with a plurality of quench streams injected into the plasma chamber through a plurality of quench gas injection ports, wherein the quench streams are injected at flow rates and injection angles that result in the impingement of the quench streams with each other within the gaseous product stream, thereby producing ultrafine solid particles; and (d) passing the ultrafine solid particles through a converging member.

In certain embodiments of the coating compositions of the present invention, the corrosion resisting particles comprise an inorganic oxide network comprising one or more inorganic materials. As used herein, the term “inorganic oxide network comprising one or more inorganic materials” refers to a molecular chain comprising one, or, in some cases, two or more different inorganic materials chemically connected to each other through one or more oxygen atoms. Such a network may be formed from hydrolysis of metal salts, examples of which include, but are not limited to, Ce³⁺, Ce⁴⁺, Zn²⁺, Mg²⁺, Y³⁺, Ca²⁺, Mn⁷⁺, and Mo⁶⁺. In certain embodiments, the inorganic oxide network comprises zinc, cerium, yttrium, manganese, magnesium, or calcium. In certain embodiments, the inorganic oxide network also comprises silicon, phosphorous, and/or boron.

In certain embodiments, the inorganic oxide network comprises silicon resulting from the hydrolysis of an organosilane, such as silanes comprising two, three, four, or more alkoxy groups. Specific examples of suitable organosilanes include methyltrimethoxysilane, methyltriethoxysilane, methyltrimethoxysilane, methyltriacetoxysilane, methyltripropoxysilane, methyltributoxysilane, ethyltrimethoxysilane, ethyltriethoxysilane, γ-meth-acryloxypropyltrimethoxysilane, γ-aminopropyltrimethoxysilane, γ-aminopropyltriethoxysilane, γ-mercaptopropyltrimethoxysilane, chloromethyltrimethoxysilane, chloromethytriethoxysilane, dimethyldiethoxysilane, γ-chloropropylmethyldimethoxysilane, γ-chloropropylmethyldiethoxysilane, tetramethoxysilane, tetraethoxysilane, tetra-n-propoxysilane, tetra-n-butoxysilane, glycidoxymethyltriethoxysilane, α-glycidoxyethyltrimethoxysilane, α-glycidoxyethyltriethoxysilane, β-glycidoxyethyltrimethoxysilane, β-glycidoxyethyltriethoxysilane, α-glycidoxy-propyltrimethoxysilane, α-glycidoxypropyltriethoxysilane, β-glycidoxypropyltrimethoxysilane, β-glycidoxypropyltriethoxysilane, γ-glycidoxypropyltrimethoxysilane, γ-glycidoxypropylmethyldimethoxysilane, γ-glycidoxy-propyldimethylethoxysilane, hydrolysates thereof, oligomers thereof and mixtures of such silane monomers. In certain embodiments, the inorganic oxide network comprises silicon resulting from sodium silicate.

In certain embodiments, the inorganic oxide network is formed by combining one, or in some cases, two or more metal salts, such as metal acetates and/or nitrates, with water to produce a hydrolyzed species comprising a polyvalent metal ion. The hydrolyzed species is then reacted with the silane (or phosphorous or boron as the case may be) to produce an inorganic oxide network comprising one or more inorganic materials.

In certain embodiments of the coating compositions of the present invention, the corrosion resisting particles comprise a clay. In certain embodiments, such clays are treated with a lanthanide and/or transition metal salt. Suitable clays include, for example, layer structured Laponite® (a hydrous sodium lithium magnesium silicate modified with tetra sodium pyrophosphate commercially available from Southern Clay Products, Inc.) and bentonite (an aluminum phyllosilicate generally impure clay consisting mostly of montmorillonite, (Na,Ca)_{0.33}(Al,Mg)₂Si₄O₁₀(OH)₂·nH₂O).

Such corrosion resisting particles may be produced by adding a clay, such as the layer structured Laponite® referenced above, to a stirred dilute solution of a metal salt (up to 50% by weight metal), such as, for example, cerium acetate or zinc acetate, in water and filtering off the resulting solid precipitate. The solid precipitate may, if desired, be washed, such as with water and/or acetone, and dried.

In certain embodiments, the present invention is directed to coating compositions that comprise corrosion resisting particles comprising an inorganic oxide in combination with a pH buffering agent, such as, for example, a borate. As used herein, the term “pH buffering agent” is meant to refer to a material that adjusts the pH of the inorganic oxide to a level higher than the pH would be in the absence of the material. In certain embodiments, such corrosion resisting particles comprise a mixed metal oxide that includes borate (B₂O₃), and one or more oxides of zinc, barium, cerium, yttrium, magnesium, molybdenum, lithium, aluminum, or calcium. In certain embodiments, such an inorganic oxide is deposited on and/or within a support.

As used herein, the term “support” refers to a material upon which or in which another material is carried. In certain embodiments, the corrosion resisting particles comprise an inorganic oxide, a borate, and a silica support, such as fumed silica, commercially available under the tradename Aerosil® from Degussa, or precipitated silica, such as Hi-Sil® T600 from PPG Industries, Pittsburgh, Pa. In certain embodiments, the support has an average primary particle size of no more than 20 nanometers. In certain embodiments, such corrosion resisting particles provide desirable protection against both edge corrosion and scribe-corrosion on the surface of a substrate that is exposed to anodic dissolution.

Specific non-limiting examples of suitable corrosion resisting particles comprising a mixed metal oxide including borate comprise CaO.B₂O₃, BaO.B₂O₃, ZnO.B₂O₃, and/or MgO.B₂O₃. Such corrosion resisting pigments can be produced, for example, by precipitating the such materials on the support. Such precipitation may be conducted by, for example, combining boric acid and one or more precursor materials comprising zinc, barium, cerium, yttrium, magnesium, molybdenum, lithium, aluminum, or calcium, with a slurry of water and silica, evaporating the water, and then calcining the resulting material to produce the corrosion resisting particles, which may then be milled to a desired particle size.

In certain embodiments, such particles may also comprise additional materials, such as phosphates, silicates, hydroxy-phosphates, and/or hydroxy-silicates of a metal, such as zinc or aluminum.

In certain embodiments, the corrosion resisting particles comprising an inorganic oxide in combination with a pH buffering agent, such as, for example, a borate, as described immediately above, also combined with a polyamine, which, the inventors have discovered, can improve the humidity resistance of the resulting coating composition, particularly when the previously described corrosion resisting particles include a borate.

As used herein, the term “polyamine” refers to a compound comprising two or more amines within its molecular structure. In certain embodiments of the present invention, the polyamine comprises a polyaliphatic polyamine, such as, for example, polyethylene polyamines, tetraethylenepentamine, and/or pentaethylenehexamine. In certain embodiments, the polyamine comprises a mixture of linear, branched, and cyclic ethylenamines having polyethylene polyamines (CAS #68131-73-7 or CAS #29230-38-5), pentaethylenehexamines (CAS #4067-16-7), tetraethylenepentamines (CAS # 112-57-2), and triethylenetetramines (CAS #112-24-3) as components, which is commercially available from Dow Chemical as Heavy Polyamine X (HPA-X).

Specific examples of corrosion resisting particles comprising an inorganic oxide in combination with a pH buffering agent, which are suitable for use in the present invention include particles comprising: (a) CaO.B₂O₃, BaO.B₂O₃, ZnO.B₂O₃, and/or MgO.B₂O₃, optionally deposited on and/or within a support, such as fumed silica; (b) Zn₂SiO₄, Zn₃(PO₄)₂, AlPO₄, (ZnOH)₄SiO₄, and/or Znₓ(OH)_{y}(PO4)_{z}, optionally disposed on and/or within a support; (c) mixtures of (a) and (b); and mixtures of any of (a), (b), or (c) with a polyamine, such as the previously described polyaliphatic amine(s).

In certain embodiments, one or more of the previously described corrosion resisting particles are present in the coating compositions of the present invention in an amount of 3 to 50 percent by volume, such as 8 to 30 percent by volume, or, in certain embodiments, 10 to 18 percent by volume, wherein the volume percents are based on the total volume of the coating composition.

As previously indicated, in certain embodiments, the coating compositions of the present invention comprise a film-forming resin. As used herein, the term “film-forming resin” refers to resins that can form a self-supporting continuous film on at least a horizontal surface of a substrate upon removal of any diluents or carriers present in the composition or upon curing at ambient or elevated temperature.

Film-forming resins that may be used in the coating compositions of the present invention include, without limitation, those used in automotive OEM coating compositions, automotive refinish coating compositions, industrial coating compositions, architectural coating compositions, coil coating compositions, and aerospace coating compositions, among others.

In certain embodiments, the film-forming resin included within the coating compositions of the present invention comprises a thermosetting film-forming resin. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting resin will not melt upon the application of heat and is insoluble in solvents. In other embodiments, the film-forming resin included within the coating compositions of the present invention comprises a thermoplastic resin. As used herein, the term “thermoplastic” refers to resins that comprise polymeric components that are not joined by covalent bonds and thereby can undergo liquid flow upon heating and are soluble in solvents. See Saunders, K. J., Organic Polymer Chemistry, pp. 41-42, Chapman and Hall, London (1973).

Film-forming resins suitable for use in the coating compositions of the present invention include, for example, those formed from the reaction of a polymer having at least one type of reactive group and a curing agent having reactive groups reactive with the reactive group(s) of the polymer. As used herein, the term “polymer” is meant to encompass oligomers, and includes, without limitation, both homopolymers and copolymers. The polymers can be, for example, acrylic, saturated or unsaturated polyester, polyurethane or polyether, polyvinyl, cellulosic, acrylate, silicon-based polymers, co-polymers thereof, and mixtures thereof, and can contain reactive groups such as epoxy, carboxylic acid, hydroxyl, isocyanate, amide, carbamate and carboxylate groups, among others, including mixtures thereof.

Suitable acrylic polymers include, for example, those described in United States Patent Application Publication 2003/0158316 A1 at [0030]-[0039], the cited portion of which being incorporated herein by reference. Suitable polyester polymers include, for example, those described in United States Patent Application Publication 2003/0158316 A1 at [0040]-[0046], the cited portion of which being incorporated herein by reference. Suitable polyurethane polymers include, for example, those described in United States Patent Application Publication 2003/0158316 A1 at [0047]-[0052], the cited portion of which being incorporated herein by reference. Suitable silicon-based polymers are defined in U.S. Pat. No. 6,623,791 at col. 9, lines 5-10, the cited portion of which being incorporated herein by reference.

In certain embodiments of the present invention, the film-forming resin comprises a polyvinyl polymer, such as a polyvinyl butyral resin. Such resins may be produced by reacting a polyvinyl alcohol with an aldehyde, such as acetaldehyde, formaldehyde, or butyraldehyde, among others. Polyvinyl alcohols may be produced by the polymerization of vinyl acetate monomer and the subsequent, alkaline-catalyzed methanolysis of the polyvinyl acetate obtained. The acetalization reaction of polyvinyl alcohol and butyraldehyde is not quantitative, so the resulting polyvinyl butyral may contain a certain amount of hydroxyl groups. In addition, a small amount of acetyl groups may remain in the polymer chain.

Commercially available polyvinyl butyral resins may be used. Such resins often have an average degree of polymerization of 500 to 1000 and a degree of buyration of 57 to 70 mole percent. Specific examples of suitable polyvinyl butyral resins include the MOWITAL® line of polyvinyl butyral resins commercially available from Kuraray America, Inc., New York, N.Y.

As indicated earlier, certain coating compositions of the present invention can include a film-forming resin that is formed from the use of a curing agent. As used herein, the term “curing agent” refers to a material that promotes “cure” of composition components. As used herein, the term “cure” means that any crosslinkable components of the composition are at least partially crosslinked. In certain embodiments, the crosslink density of the crosslinkable components, i.e., the degree of crosslinking, ranges from 5 percent to 100 percent of complete crosslinking, such as 35 percent to 85 percent of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

Any of a variety of curing agents known to those skilled in the art may be used. For example exemplary suitable aminoplast and phenoplast resins are described in U.S. Pat. No. 3,919,351 at col. 5, line 22 to col. 6, line 25, the cited portion of which being incorporated herein by reference. Exemplary suitable polyisocyanates and blocked isocyanates are described in U.S. Pat. No. 4,546,045 at col. 5, lines 16 to 38; and in U.S. Pat. No. 5,468,802 at col. 3, lines 48 to 60, the cited portions of which being incorporated herein by reference. Exemplary suitable anhydrides are described in U.S. Pat. No. 4,798,746 at col. 10, lines 16 to 50; and in U.S. Pat. No. 4,732,790 at col. 3, lines 41 to 57, the cited portions of which being incorporated herein by reference. Exemplary suitable polyepoxides are described in U.S. Pat. No. 4,681,811 at col. 5, lines 33 to 58, the cited portion of which being incorporated herein by reference. Exemplary suitable polyacids are described in U.S. Pat. No. 4,681,811 at col. 6, line 45 to col. 9, line 54, the cited portion of which being incorporated herein by reference. Exemplary suitable polyols are described in U.S. Pat. No. 4,046,729 at col. 7, line 52 to col. 8, line 9 and col. 8, line 29 to col. 9, line 66, and in U.S. Pat. No. 3,919,315 at col. 2, line 64 to col. 3, line 33, the cited portions of which being incorporated herein by reference. Examples suitable polyamines described in U.S. Pat. No. 4,046,729 at col. 6, line 61 to col. 7, line 26, and in U.S. Pat. No. 3,799,854 at column 3, lines 13 to 50, the cited portions of which being incorporated herein by reference. Appropriate mixtures of curing agents, such as those described above, may be used.

In certain embodiments, the coating compositions of the present invention are formulated as a one-component composition where a curing agent is admixed with other composition components to form a storage stable composition. In other embodiments, compositions of the present invention can be formulated as a two-component composition where a curing agent is added to a pre-formed admixture of the other composition components just prior to application.

In certain embodiments, the film-forming resin is present in the coating compositions of the present invention in an amount greater than 30 weight percent, such as 40 to 90 weight percent, or, in some cases, 50 to 90 weight percent, with weight percent being based on the total weight of the coating composition. When a curing agent is used, it may, in certain embodiments, be present in an amount of up to 70 weight percent, such as 10 to 70 weight percent; this weight percent is also based on the total weight of the coating composition.

In certain embodiments, the coating compositions of the present invention are in the form of liquid coating compositions, examples of which include aqueous and solvent-based coating compositions and electrodepositable coating compositions. The coating compositions of the present invention may also be in the form of a co-reactable solid in particulate form, i.e., a powder coating composition. Regardless of the form, the coating compositions of the present invention may be pigmented or clear, and may be used alone or in combination as primers, basecoats, or topcoats. Certain embodiments of the present invention, as discussion in more detail below, are directed to corrosion resistant primer and/or pretreatment coating compositions. As indicated, certain embodiments of the present invention are directed to metal substrate primer coating compositions, such as “etch primers,” and/or metal substrate pretreatment coating compositions. As used herein, the term “primer coating composition” refers to coating compositions from which an undercoating may be deposited onto a substrate in order to prepare the surface for application of a protective or decorative coating system. As used herein, the term “etch primer” refers to primer coating compositions that include an adhesion promoting component, such as a free acid as described in more detail below. As used herein, the term “pretreatment coating composition” refers to coating compositions that can be applied at very low film thickness to a bare substrate to improve corrosion resistance or to increase adhesion of subsequently applied coating layers. Metal substrates that may be coated with such compositions include, for example, substrates comprising steel (including electrogalvanized steel, cold rolled steel, hot-dipped galvanized steel, among others), aluminum, aluminum alloys, zinc-aluminum alloys, and aluminum plated steel. Substrates that may be coated with such compositions also may comprise more than one metal or metal alloy, in that the substrate may be a combination of two or more metal substrates assembled together, such as hot-dipped galvanized steel assembled with aluminum substrates.

The metal substrate primer coating compositions and/or metal substrate pretreatment coating compositions of the present invention may be applied to bare metal. By “bare” is meant a virgin material that has not been treated with any pretreatment compositions, such as, for example, conventional phosphating baths, heavy metal rinses, etc. Additionally, bare metal substrates being coated with the primer coating compositions and/or pretreatment coating compositions of the present invention may be a cut edge of a substrate that is otherwise treated and/or coated over the rest of its surface.

Before applying a primer coating composition of the present invention and/or a metal pretreatment composition of the present invention, the metal substrate to be coated may first be cleaned to remove grease, dirt, or other extraneous matter. Conventional cleaning procedures and materials may be employed. These materials could include, for example, mild or strong alkaline cleaners, such as those that are commercially available. Examples include BASE Phase Non-Phos or BASE Phase #6, both of which are available from PPG Industries, Pretreatment and Specialty Products. The application of such cleaners may be followed and/or preceded by a water rinse.

The metal surface may then be rinsed with an aqueous acidic solution after cleaning with the alkaline cleaner and before contact with a metal substrate primer coating composition and/or metal substrate pretreatment composition of the present invention. Examples of suitable rinse solutions include mild or strong acidic cleaners, such as the dilute nitric acid solutions commercially available.

As previously indicated, certain embodiments of the present invention are directed to coating compositions comprising an adhesion promoting component. As used herein, the term “adhesion promoting component” refers to any material that is included in the composition to enhance the adhesion of the coating composition to a metal substrate.

In certain embodiments of the present invention, such an adhesion promoting component comprises a free acid. As used herein, the term “free acid” is meant to encompass organic and/or inorganic acids that are included as a separate component of the compositions of the present invention as opposed to any acids that may be used to form a polymer that may be present in the composition. In certain embodiments, the free acid included within the coating compositions of the present invention is selected from tannic acid, gallic acid, phosphoric acid, phosphorous acid, citric acid, malonic acid, a derivative thereof, or a mixture thereof. Suitable derivatives include esters, amides, and/or metal complexes of such acids.

In certain embodiments, the free acid comprises an organic acid, such as tannic acid, i.e., tannin. Tannins are extracted from various plants and trees which can be classified according to their chemical properties as (a) hydrolyzable tannins, (b) condensed tannins, and (c) mixed tannins containing both hydrolyzable and condensed tannins. Tannins useful in the present invention include those that contain a tannin extract from naturally occurring plants and trees, and are normally referred to as vegetable tannins. Suitable vegetable tannins include the crude, ordinary or hot-water-soluble condensed vegetable tannins, such as Quebracho, mimosa, mangrove, spruce, hemlock, gabien, wattles, catechu, uranday, tea, larch, myrobalan, chestnut wood, divi-divi, valonia, summac, chinchona, oak, etc. These vegetable tannins are not pure chemical compounds with known structures, but rather contain numerous components including phenolic moieties such as catechol, pyrogallol, etc., condensed into a complicated polymeric structure.

In certain embodiments, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are metal phosphates, organophosphates, and organophosphonates. Suitable organophosphates and organophosphonates include those disclosed in U.S. Pat. No. 6,440,580 at col. 3, line 24 to col. 6, line 22, U.S. Pat. No. 5,294,265 at col. 1, line 53 to col. 2, line 55, and U.S. Pat. No. 5,306,526 at col. 2, line 15 to col. 3, line 8, the cited portions of which being incorporated herein by reference. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790.

In certain embodiments, the adhesion promoting component comprises a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at col. 3, lines 19 to 62, the cited portion of which being incorporated by reference herein.

In certain embodiments, the adhesion promoting component is present in the metal substrate primer coating compositions and/or the metal pretreatment coating composition in an amount ranging from 0.05 to 20 percent by weight, such as 3 to 15 percent by weight, with the percents by weight being based on the total weight of the composition.

As previously indicated, in certain embodiments, such as embodiments where the coating compositions of the present invention comprise a metal substrate primer coating composition and/or a metal pretreatment composition, the composition may also comprise a film-forming resin. In certain embodiments, the film-forming resin is present in such compositions in an amount ranging from 20 to 90 percent by weight, such as 30 to 80 percent by weight, with the percents by weight being based on the total weight of the composition.

In certain embodiments, the coating compositions of the present invention may also comprise additional optional ingredients, such as those ingredients well known in the art of formulating surface coatings. Such optional ingredients may comprise, for example, pigments, dyes, surface active agents, flow control agents, thixotropic agents, fillers, anti-gassing agents, organic co-solvents, catalysts, antioxidants, light stabilizers, UV absorbers and other customary auxiliaries. Any such additives known in the art can be used, absent compatibility problems. Non-limiting examples of these materials and suitable amounts include those described in U.S. Pat. Nos. 4,220,679; 4,403,003; 4,147,769; and 5,071,904.

In certain embodiments, the coating compositions of the present invention also comprise, in addition to any of the previously described corrosion resisting particles, conventional non-chrome corrosion resisting particles. Suitable conventional non-chrome corrosion resisting particles include, but are not limited to, iron phosphate, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W. R. Grace & Co. as SHIELDEX® AC3 and/or SHIELDEX® C303. Suitable amorphous silica is available from W. R. Grace & Co. under the tradename SYLOID®. Suitable zinc hydroxyl phosphate is commercially available from Elementis Specialties, Inc. under the tradename NALZIN® 2. Modification of the foregoing materials are also suitable, such as the modified orthophosphates commercially available from Heubach GmbH, including, for example, zinc aluminium phosphate hydrate, organic-modified basic zinc phosphate hydrates, basic zinc molybdenum phosphate hydrates, modified zinc calcium strontium phosphate silicate hydrates, organic/inorganic modified basic zinc phosphate hydrates, organic/inorganic modified basic zinc phosphate silicate hydrates, and anhydrous calcium hydrogen phosphate.

These conventional non-chrome corrosion resisting pigments typically comprise particles having a particle size of approximately one micron or larger. In certain embodiments, these particles are present in the coating compositions of the present invention in an amount ranging from 5 to 40 percent by weight, such as 10 to 25 percent by weight, with the percents by weight being based on the total solids weight of the composition.

In certain embodiments, the present invention is directed to coating compositions comprising an adhesion promoting component, a phenolic resin and an alkoxysilane, in addition to any of the previously described corrosion resisting particles. Suitable phenolic resins include those resins prepared by the condensation of a phenol or an alkyl substituted phenol with an aldehyde. Exemplary phenolic resins include those described in U.S. Pat. No. 6,774,168 at col. 2, lines 2 to 22, the cited portions of which being incorporated herein by reference. Suitable alkoxysilanes are described in U.S. Pat. No. 6,774,168 at col. 2, lines 23 to 65 and include, for example, acryloxyalkoxysilanes, such as γ-acryloxypropyltrimethoxysilane and methacrylatoalkoxysilane, such as γ-methacryloxypropyltrimethoxysilane. Such compositions may also include a solvent, rheological agent, and/or pigment, as described in U.S. Pat. No. 6,774,168 at col. 3, lines 28 to 41, the cited portion of which being incorporated by reference herein.

The coating compositions of the present invention may be prepared by any of a variety of methods. For example, in certain embodiments, the previously described corrosion resisting particles are added at any time during the formulation of a coating composition comprising a film-forming resin, so long as they form a stable suspension in a film-forming resin. Coating compositions of the present invention can be prepared by first blending a film-forming resin, the previously described corrosion resisting particles, and a diluent, such as an organic solvent and/or water, in a closed container that contains ceramic grind media. The blend is subjected to high shear stress conditions, such as by shaking the blend on a high speed shaker, until a homogeneous dispersion of particles remains suspended in the film-forming resin with no visible particle settle in the container. If desired, any mode of applying stress to the blend can be utilized, so long as sufficient stress is applied to achieve a stable dispersion of the particles in the film-forming resin.

The coating compositions of the present invention may be applied to a substrate by known application techniques, such as dipping or immersion, spraying, intermittent spraying, dipping followed by spraying, spraying followed by dipping, brushing, or by roll-coating. Usual spray techniques and equipment for air spraying and electrostatic spraying, either manual or automatic methods, can be used. While the coating compositions of the present invention can be applied to various substrates, such as wood, glass, cloth, plastic, foam, including elastomeric substrates and the like, in many cases, the substrate comprises a metal.

In certain embodiments of the coating compositions of the present invention, after application of the composition to the substrate, a film is formed on the surface of the substrate by driving solvent, i.e., organic solvent and/or water, out of the film by heating or by an air-drying period. Suitable drying conditions will depend on the particular composition and/or application, but in some instances a drying time of from about 1 to 5 minutes at a temperature of about 80 to 250° F. (20 to 121° C.) will be sufficient. More than one coating layer may be applied if desired. Usually between coats, the previously applied coat is flashed; that is, exposed to ambient conditions for 5 to 30 minutes. In certain embodiments, the thickness of the coating is from 0.05 to 5 mils (1.3 to 127 microns), such as 0.05 to 3.0 mils (1.3 to 76.2 microns). The coating composition may then be heated. In the curing operation, solvents are driven off and crosslinkable components of the composition, if any, are crosslinked. The heating and curing operation is sometimes carried out at a temperature in the range of from 160 to 350° F. (71 to 177° C.) but, if needed, lower or higher temperatures may be used.

As indicated, certain embodiments of the coating compositions of the present invention are directed to primer compositions, such as “etch primers,” while other embodiments of the present invention are directed to metal substrate pretreatment compositions. In either case, such compositions are often topcoated with a protective and decorative coating system, such as a monocoat topcoat or a combination of a pigmented base coating composition and a clearcoat composition, i.e., a color-plus-clear system. As a result, the present invention is also directed to multi-component composite coatings comprising at least one coating layer deposited from a coating composition of the present invention. In certain embodiments, the multi-component composite coating compositions of the present invention comprise a base-coat film-forming composition serving as a basecoat (often a pigmented color coat) and a film-forming composition applied over the basecoat serving as a topcoat (often a transparent or clear coat).

In these embodiments of the present invention, the coating composition from which the basecoat and/or topcoat is deposited may comprise, for example, any of the conventional basecoat or topcoat coating compositions known to those skilled in the art of, for example, formulating automotive OEM coating compositions, automotive refinish coating compositions, industrial coating compositions, architectural coating compositions, coil coating compositions, and aerospace coating compositions, among others. Such compositions typically include a film-forming resin that may include, for example, an acrylic polymer, a polyester, and/or a polyurethane. Exemplary film-forming resins are disclosed in U.S. Pat. No. 4,220,679, at col. 2 line 24 to col. 4, line 40; as well as U.S. Pat. No. 4,403,003, U.S. Pat. No. 4,147,679 and U.S. Pat. No. 5,071,904.

The present invention is also directed to substrates, such as metal substrates, at least partially coated with a coating composition of the present invention as well as substrates, such as metal substrates, at least partially coated with a multi-component composite coating of the present invention.

Illustrating the invention are the following examples, which, however, are not to be considered as limiting the invention to their details. Unless otherwise indicated, all parts and percentages in the following examples, as well as throughout the specification, are by weight.

### EXAMPLES

The following Particle Examples describe the preparation of corrosion resisting particles suitable for use in certain embodiments of the coating compositions of the present invention.

### Particle Example 1

Corrosion resisting particles comprising calcium borate disposed on and/or within a silica support were prepared according to the following reaction scheme:
CaO+H₂O→Ca(OH)₂
Ca(OH)₂+2H₃BO₃→CaO.B₂O₃+4H₂O
60.00 g of the fumed silica was slowly added to 1000 ml of water suspension 4.67 g of calcium oxide. The mixture was vigorously stirred. Then, 230 ml of 4.5% boric acid was added and the resulting suspension was stirred for 30 minutes. The sample was dried in a vacuum rotary evaporator at 80-110° C., and calcined at 500° C. for 1 h.

### Particle Example 2

Corrosion resisting particles comprising zinc phosphate disposed on and/or within a silica support were prepared according to the following reaction scheme:
3ZnCl₂+2(NH₄)₂HPO₄→Zn₃(PO₄)₂+4NH₄Cl+2HCl
A suspension of 60.00 g of the fumed silica and 800 ml of distilled water was heated up to 95° C. while vigorously stirring. The heated up to 95° C. zinc chloride solution (3.10 g in 100 ml of distilled water and 0.5 ml+several drops of 2 N solution of hydrochloric acid) was then slowly added to the silica suspension. Then ammonium phosphate (dibasic) solution (2.01 g in 100 ml of distilled water) was heated and added very slowly (by drops). The resulting suspension was stirred and heated at 95° C. for 30 minutes. The sample was dried in a vacuum rotary evaporator at 80-110° C., calcined at 450° C.

### Particle Example 3

Corrosion resisting particles were prepared by milling for 1 hour a mixture of the corrosion resisting particles prepared in Particle Example 1 and Particle 2. The particles were mixed in a 1:1 weight ratio.

### Particle Example 4

Corrosion resisting particles comprising zinc borate disposed on and/or within a silica support were prepared according to the following reaction scheme:
Zn(Ac)₂.2H₂O+2H₃BO₃→ZnO.B₂O₃+2HAc+4H₂O
A suspension of 60.00 g of the silica and 500 ml of distilled water was vigorously stirred. The zinc acetate solution (4.00 g Zn(Ac)₂.2H₂O in 100 ml of distilled water) was slowly added to the silica suspension. Then, 76 ml of 4.5% boric acid was added and the resulting suspension was dried in a vacuum rotary evaporator at 80-110° C., and calcined at 550° C. for 1 h.

### Particle Example 5

Corrosion resisting particles comprising zinc borate disposed on and/or within a silica support were prepared according to the following reaction scheme:
Al(NO₃)₃+(NH₄)₂HPO₄→AlPO₄+2NH₄NO₃+HNO₃
A suspension of 60.00 g of the silica and 500 ml of distilled water was vigorously stirred. The ammonium phosphate (dibasic) solution (3.04 g in 100 ml of distilled water) was slowly added to the silica suspension. Then, the aluminum nitrate nonahydrate solution (8.32 g in 150 ml of distilled water) was added slowly. The resulting suspension was stirred for 30 minutes. The sample was then dried in a vacuum rotary evaporator at 80-110° C., and calcined at 300° C. for 1 h.

### Particle Example 6

Corrosion resisting particles were prepared by milling for 2 hour a mixture of 50 grams of the corrosion resisting particles prepared in Particle Example 4, with 50 grams of the corrosion resisting particles prepared in Particle Example 5, with 3 grams of HPA-X.

### Particle Example 7

Corrosion resisting particles comprising calcium borate disposed were prepared according to the following reaction scheme:
CaO+H₂O→Ca(OH)₂
Ca(OH)₂+2H₃BO₃→CaO.B₂O₃+4H₂O
A mixture of 1500 ml distilled water and 22.29 g of calcium oxide was vigorously stirred. Then, 49.20 g boric acid in 1500 ml distilled water was added and the resulting suspension was stirred for 30 minutes. The sample was dried in a vacuum rotary evaporator at 80-110° C., and calcined at 500° C. for 1 h.

### Particle Example 8

Corrosion resisting particles comprising zinc phosphate were prepared according to the following reaction scheme:
3ZnCl₂+2(NH₄)₂HPO₄→Zn₃(PO₄)₂+4NH₄Cl+2HCl
A zinc chloride solution (52.95 g in 500 ml of distilled water and 5 ml of 2 N solution of hydrochloric acid was heated up to 95° C. and slowly added to ammonium phosphate (dibasic) solution (34.21 g in 500 ml of distilled water, 95° C.). The resulting suspension was stirred and heated at 95° C. for 30 minutes. The sample was dried in a vacuum rotary evaporator at 80-110° C., calcined at 450° C.

### Particle Example 9

Corrosion resisting particles were prepared by milling for 2 hours a mixture of 50 grams of the corrosion resisting particles prepared in Particle Example 7, with 50 grams of the corrosion resisting particles prepared in Particle Example 8.

### Coating Composition Examples

Coating compositions were prepared using the components and weights (in grams) shown in Table 1. Coatings were prepared by adding components 1 to 10 to a suitable vessel under agitation with a blade and mix with zircoa beads for approximately 30 minutes to achieve a 7 Hegman. Next, components 11 to 15 were added while under agitation and left to mix for 10 minutes. After mixing the coating the milling beads were filtered out with a standard paint filter and the finished material was ready for application.

TABLE 1

| Component | | Exam- | Exam- | Exam- | Exam- |
|---|---|---|---|---|---|
| No. | Material | ple 1 | ple 2 | ple 3 | ple 4 |
| 1 | Polyester Resin¹ | 23.1 | 69.2 | 69.2 | 70.0 |
| 2 | Phosphatized | 8.1 | 8.2 | 8.2 | 8.1 |
| | Epoxy² | | | | |
| 3 | Solvesso 100³ | 32.7 | 45.4 | 45.4 | 30.0 |
| 4 | Butyl Cellosolve⁴ | 20.4 | 30.0 | 30.0 | 30.0 |
| 5 | Ti-Pure R960⁵ | 15.0 | 22.3 | 22.3 | 22.2 |
| 6 | ASP-200 Clay⁶ | 22.2 | 33.2 | 33.2 | 33.1 |
| 7 | Shieldex C303⁷ | 15.6 | — | — | — |
| 8 | Hecuophos ZP-10⁸ | 9.3 | — | — | — |
| 9 | K-White TC720⁹ | | | | 11.7 |
| 10 | Particle Example 3 | — | 37.4 | — | — |
| | Particle Example 9 | — | — | 37.4 | — |
| | Particle Example 6 | — | — | — | 23.0 |
| 11 | Polyester Resin¹ | 98.2 | 52.1 | 52.1 | 51.2 |
| 12 | Cymel 1123¹⁰ | 16.2 | 16.3 | 16.3 | 16.3 |
| 13 | Solvesso 100³ | 10.9 | 12.1 | 12.1 | 12.0 |
| 14 | N-Butanol¹¹ | 3.0 | 3.0 | 3.0 | 3 |
| 15 | CYCAT 4040¹² | 0.5 | 0.5 | 0.5 | 0.5 |
| ¹Polyester resin prepared by adding Charge #1 (827.6 grams 2-methyl 1,3-propanediol, 47.3 grams trimethylol propane, 201.5 grams adipic acid, 663.0 grams isophthalic acid, and 591.0 grams phthalic anhydride) to a round-bottomed, 4-necked flask equipped with a motor driven stainless steel stir blade, a packed column connected to a water cooled condenser and a heating mantle with a thermometer connected through a temperature feed-back control device. The reaction mixture | | | | | |
| # was heated to 120° C. in a nitrogen atmosphere. All components were melted when the reaction mixture reached 120° C. and the reaction was then heated to 170° C. at which temperature the water generated by the esterification reaction began to be collected. The reaction temperature was maintained at 170° C. until the distillation of water began to significantly slow, at which point the reaction temperature was increased by 10° C. This stepwise temperature increase | | | | | |
| # was repeated until the reaction temperature reached 240° C. When the distillation of water at 240° C. stopped, the reaction mixture was cooled to 190° C., the packed column replaced with a Dean-Stark and a nitrogen sparge was started. Charge #2 (100.0 grams Solvesso 100 and 2.5 grams titanium (IV) tetrabutoxide) was added and the reaction was heated to reflux (˜220° C.) with continuous removal of the water collected in the Dean-Stark trap. The reaction | | | | | |
| # mixture was held at reflux until the measured acid value was less than 8.0 mg KOH/gram. The resin was cooled, thinned with Charge #3 (1000.0 grams Solvesso 110), discharged and analyzed. The determined acid value was 5.9 mg KOH/gram, and the determined hydroxy value of 13.8 mg KOH/gram. The determined non-volatile content of the resin was 64.1% as measured by weight loss of a sample heated to 110° C. for 1 hour. Analysis of the polymer by GPC (using linear | | | | | |
| # polystyrene standards) showed the polymer to have an M_{w} value of 17,788, Mₙ value of 3,958, and an M_{w}/Mₙ value of 4.5. | | | | | |
| ²Phosphatized epoxy resin prepared by dissolving 83 parts by weight of EPON 828 epoxy resin (a polyglycidyl ether of bisphenol A, commercially available from Resolution Performance Products) in 20 parts by weight 2-butoxyethanol. The epoxy resin solution was subsequently added to a mixture of 17 parts by weight of phosphoric acid and 25 parts by weight 2-butoxyethanol under nitrogen atmosphere. The blend was agitated for about 1.5 hours at a temperature | | | | | |
| # of about 115° C. to form a phosphatized epoxy resin. The resulting resin was further diluted with 2-butoxyethanol to produce a composition which was about 55 percent by weight solids. | | | | | |

³Commercially available from Exxon.
⁴Commercially available from Dow Chemical.
⁵Commercially available from DuPont.
⁶Commercially available from Engelhard Corp.
⁷Commercially available from Grace.
⁸Commercially available from Heubach.
⁹Commercially available from Tayca.
¹⁰Commercially available from Cytec.
¹¹Commercially available from Exxon.
¹²Commercially available from King Industries.

### Test Substrate Preparation

The primer compositions of Tables 1 were applied over G90 HDG steel pretreated with Bonderite® 1455 (commercially available from Henkel Surface Technologies) using a wire wound drawdown bar. Each primer composition was applied at approximately 0.2 mils dry film thickness and cured in a gas-fired oven for 30 seconds at 450° F. peak metal temperature. Subsequently, a coil topcoat (Durastar™ HP 9000 commercially available from PPG Industries) was applied over the primer with a wire wound drawdown bar at approximately 0.75 mils dry film thickness and cured in a gas fired oven for 30 seconds at 450° F. peak metal temperature.

### Salt Spray Results

Salt spray panels were prepared by cutting a panel to approximately 4 inches wide and 5 inches long. The left and right edges were cut down with a metal shear. The face of the panels were scribed in the middle with a vertical and horizontal scribe approximately 1.5 inches long and separated by approximately 0.5 inches. This is achieved with a tungsten tip tool and extends down just through the organic coating.

Salt spray resistance was tested as described in ASTM B117. Panels were removed from salt spray testing after 500 hours. Immediately after salt spray the panels were washed with warm water, scribes and cut edges were scraped with a wooden spatula to remove salt build-up and then dried with a towel. After which panels were taped with Scotch 610 tape to remove blistered coating.

Panels were evaluated for face blistering, cut edge creep, and scribe creep. Face blistering was measured according to ASTM D714-87. The cut edge values were reported as an average of the maximum creep on the left and right cut edges in millimeters. The scribe creep values were reported as an average of the maximum creep (from scribe to creep) on the vertical and horizontal scribes in millimeters. Results are illustrated in Table 2, with lower value indicated better corrosion resistance results.

TABLE 2

| G90 HDG Steel | | | | |
|---|---|---|---|---|
| Substrate | Example 1 | Example 2 | Example 3 | Example 4¹³ |
| Face Blistering | None | Few #9 | Few #9 | None |
| Cut Edge | 5 | 1 | 4 | 5 |
| Scribe | 0.5 | 0 | 3 | 1 |

¹³Example 4 was tested on HDG steel substrate obtained from a supplier different from Examples 1-3, which is believed to explain to be the cause of the variation in cut edge corrosion results.

It will be readily appreciated by those skilled in the art that modifications may be made to the invention without departing from the concepts disclosed in the foregoing description. Such modifications are to be considered as included within the following claims unless the claims, by their language, expressly state otherwise. Accordingly, the particular embodiments described in detail herein are illustrative only and are not limiting to the scope of the invention which is to be given the full breadth of the appended claims and any and all equivalents thereof.

We claim:

1. A coating composition comprising corrosion resisting particles comprising an inorganic oxide in combination with a pH buffering agent deposited on and/or within a support.

2. The coating composition of claim 1, wherein the pH buffering agent comprises a borate.

3. The coating composition of claim 2, wherein the inorganic oxide comprises one or more oxides of zinc, barium, cerium, yttrium, magnesium, molybdenum, lithium, aluminum, or calcium.

4. The coating composition of claim 1, wherein the support is a silica.

5. The coating composition of claim 4, wherein the silica is precipitated silica.

6. The coating composition of claim 4, wherein the support has an average primary particle size of no more than 20 nanometers.

7. The coating composition of claim 2, wherein the particles comprise CaO.B₂O₃, BaO.B₂O₃, ZnO.B₂O₃, and/or MgO.B₂O₃.

8. The coating composition of claim 2, wherein the corrosion resisting particles further comprise a polyamine.

9. The coating composition of claim 8, wherein the polyamine comprises a polyaliphatic polyamine.

10. The coating composition of claim 9, wherein the polyaliphatic polyamine comprises a polyethylene polyamine, a tetraethylenepentamine, and/or a pentaethylenehexamine.

11. The coating composition of claim 1, wherein the corrosion resisting particles are selected from the group consisting of:
(a) CaO.B₂O₃, BaO.B₂O₃, ZnO.B₂O₃, and/or MgO.B₂O₃;
(b) a mixture of (a) with Zn₂SiO₄, Zn₃(PO₄)₂, AlPO₄, (ZnOH)₄SiO₄, and/or Znₓ(OH)_{y}(PO4)_{z}; and
(c) a mixture of (a) or (b) with a polyamine.

12. The coating composition of claim 1, wherein the composition is substantially free of chromium containing material.

13. The coating composition of claim 1, further comprising a film-forming resin.

14. The coating composition of claim 1, further comprising an adhesion promoting component.

15. The coating composition of claim 14, wherein the adhesion promoting component comprises phosphatized epoxy resin and/or a free acid selected from tannic acid, gallic acid, phosphoric acid, phosphorous acid, citric acid, malonic acid, a derivative thereof, or a mixture thereof.

16. The coating composition of claim 1, further comprising conventional non-chrome corrosion resisting pigment particles selected from iron phosphate, zinc phosphate, calcium ion-exchanged silica, colloidal silica, synthetic amorphous silica, and molybdates, such as calcium molybdate, zinc molybdate, barium molybdate, strontium molybdate, or a modification or mixture thereof.

17. A multi-component composite coating comprising at least one coating layer deposited from the coating composition of claim 1.

18. A metal substrate at least partially coated with the coating composition of claim 1.

19. A coating composition comprising:
(1) an adhesion promoting component, and
(2) corrosion resisting particles comprising:
(a) an inorganic oxide in combination with a pH buffering agent deposited on and/or within a support; and
(b) a polyamine.

20. A coating composition comprising corrosion resisting particles selected from the group consisting of Zn₂SiO₄, Zn₃(PO₄)₂, AlPO₄, (ZnOH)₄SiO₄, and/or Znₓ(OH)_{y}(PO4)_{z}, deposited on and/or within a support.
